(19) United States
(12) Patent Application Publication
(10) Pub. No.: US 2009/0113623 A1
(43) Pub. Date: May 7, 2009

(54) Lifting sling

(76) Inventors: Huw Thomas, Aberystwyth (GB); Dana Thomas, Cardiff (GB)

Correspondence Address: GORDON & JACOBSON, P.C., 60 LONG RIDGE ROAD, SUITE 407, STAMFORD, CT, 06902, US

(21) Appl. No.: 12/291,228

(22) Filed: Nov. 7, 2008

(30) Foreign Application Priority Data
Nov. 7, 2007 (GB) 0721830.8

(51) Int. Cl. A61G 1/00; A61G 7/053

(52) U.S. Cl. 5/89.1; 5/81.1 R

(57) ABSTRACT

A lifting sling for lifting a disabled/incapacitated person from one seat to another, or for lifting that person from a first position to a second position. The sling comprises a fabric panel having a body portion for positioning under the person's buttocks and lower back and a pair of leg portions extending from the lower end of the body, the legs portions being crossed over each other and passed under the person's legs, such that handles on the leg portions meet handles on the respective opposite side of the lower end of the body. The person can then be lifted by two or more persons, by each person taking at least one brought-together handle or another handle at the top end of the body.

### BACKGROUND OF THE INVENTION

1. Field of the Invention

This invention relates to lifting sling and more particularly to a sling used to lift a disabled or incapacitated person from one seat to another, or to lift that person from a first position to a second position.

2. Background Art

When a disabled or incapacitated person travels on an aircraft, a team of two handlers are required to lift the person from his/her wheelchair into a narrow carrying chair before boarding the aircraft. Once on board the aircraft, the person has to again be lifted into his/her seat. The same process is then carried out in reverse when leaving the aircraft.

Typically the person is lifted by one handler grasping him/her under the arms and the other person grasping the legs. It will be appreciated that this process is hazardous to both the persons being carried and the handlers.

In order to overcome this problem, it has been proposed to provide devices which can be used to lift disabled or incapacitated person. GB1381304 discloses one such device in the form of a fabric seat comprising a pair of handles on its opposite sides, which can be grasped to lift the person. A disadvantage of this device is that the person always has to be seated in the device, which is uncomfortable especially on long journeys. The device cannot merely be removed from under the person without lifting him/her by the arms and legs as hereinbefore described. Accordingly, such devices are normally retained by the disabled or incapacitated person, so that they can be placed in-situ and removed at their own convenience away from the aircraft. A disadvantage of this is that the devices are bulky to store and expensive. Furthermore, handlers still have to lift persons who do not own such a device.

GB2303331, U.S. Pat. No. 3,013,282, U.S. Pat. No. 6,289,534, EP0748619, GB2402075 and GB2419126 each disclose various forms of slings having handles at their upper and lower ends, which can be brought together and engaged by a hoist. It will be appreciated that hoists are unsuitable for use on aircraft and are expensive in construction. Furthermore, there is a risk that a person could fall out of the sling because they are not properly restrained.

I have now devised a lifting sling device which alleviates the above-mentioned problems.

### SUMMARY OF THE INVENTION

In accordance with the present invention, there is provided a lifting sling device comprising a panel of flexible sheet material having a first end, a second end opposite the first end, and opposite sides, said first end comprising a body portion formed of a substantially continuous region of said material, a pair of leg portions extending downwardly from said body region to said second end, wherein each side comprises first and second handles respectively disposed at or adjacent the first and second ends of the device and a third handle disposed intermediate said first and second ends of the device.

In use, the sheet-like construction of the device enables it to be slid under a person whilst seated, with the body portion thereof being positioned under the person's buttocks and lower back, the leg portions thereof extending under the person's respective legs. The legs portions are then crossed over and passed under the person's legs, such that the second handle on the leg portion of one side meets the third handle on the other side and visa versa. The person can then be lifted by two or more persons, by each person taking at least one of the first handles or the brought-together second and third handles.

The body portion of the device acts like a seat, with the leg portions extending under the person's legs to provide further support under the person's thighs.

Once the person has been moved, the device can easily be slid out from underneath the person and folded flat for storage.

It will be appreciated that a device in accordance with the present invention is simple and inexpensive in construction, yet enables a person to be comfortably lifted by two or more handlers with less risk of injury to themselves or the person being lifted.

Preferably the device is reinforced along its opposite sides, said reinforcement preferably being provided by strips of webbing which extend from the first handle on one side of the device to the second handle on the other side of the device.

Preferably the handles comprise loops.

Preferably the second handles on each side of the device are of a different color to each other and of the same color as the third handle on their respective opposite sides. In this manner, the colored handles provide an easy indication of how the handles on opposite sides of the device should be brought together, with the user merely having to bring together the handles of matching colors.

Preferably the first handles on each side of the device are of a different color from the second handles and are preferably the same color as each other.

Preferably the sides of the device extend outwardly between their opposite ends.

Preferably the third handle on each side is positioned closer to its respective first handle than to its respective second handle.

Preferably the legs taper inwardly towards said second end of the device.

Preferably the legs comprise divergent inner side edges.

Also in accordance with the present invention, there is provided a method of carrying a person comprising placing the person upon a lifting sling device as hereinbefore defined, such that the buttocks of the person rest upon said body portion of the device and the legs of the person extend over the respective legs of the device. The leg portions of the device are crossed over each other to bring the second handles on each side to meet the third handles on respective opposite sides. The person is lifted by grasping said pairs of brought-together handles and said first handles.

In a first method, the first handle and the brought-together handles on one side of the device are grasped by the respective hands of one person and the first handle and the brought-together handles on the other side of the device are grasped by the respective hands of another person.

In a second method, the first handles on opposite sides of the device are grasped by the respective hands of one person and the brought-together handles on opposite sides of the device are grasped by the respective hands of another person.

In a third method, the two first handles and the two sets of brought-together handles are respectively grasped by the hands of four persons.

In a fourth method, the first handles on opposite sides of the device are grasped by the respective hands of one person and the brought-together handles on opposite sides of the device are respectively grasped by the respective hands of two persons.

In a fifth method, the brought-together handles on opposite sides of the device are grasped by the respective hands of one person and the first handles on opposite sides of the device are respectively grasped by the respective hands of two persons.

### BRIEF DESCRIPTION OF THE DRAWINGS

An embodiment of the present invention will now be described by way of an example only, and with reference to the accompanying drawings.

FIG. 1 is a plan view of a lifting device in accordance with the present invention; and

FIGS. 2 to 4 are sequential diagrams illustrating how the device of FIG. 1 is used to lift a person.

### DETAILED DESCRIPTION OF THE PREFERRED EMBODIMENT

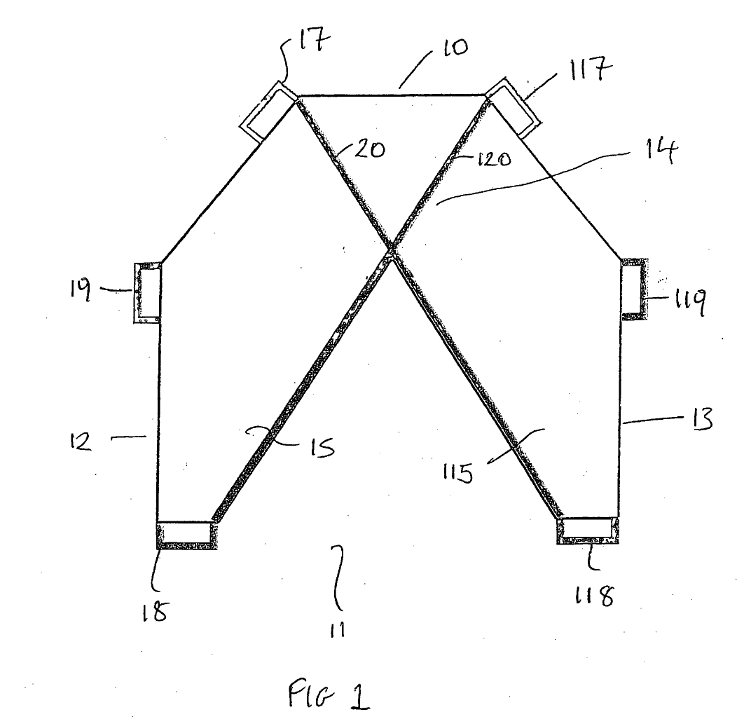

Referring to FIG. 1 of the drawings, there is shown a lifting device comprising a panel of sheet material, such as a woven fabric or mesh material having an upper end 10, a lower end 11, a left side 12 and a right side 13. The upper end 10 comprises an enlarged body region 14 of material extending transversely of the device between left and right sides 12, 13 thereof. Left and right leg portions 15, 115 extend downwardly from the body region 14 to the lower end 11 of the device. The outer side edges of the respective leg portions 15, 115 preferably extend generally parallel to each other, the inner side edges thereof diverging outwardly from a point on the lower end of the body region 14 where they meet.

The left side 12 of the lifting sling device comprises upper and lower handles 17, 18 respectively disposed adjacent upper and lower ends 10, 11 of the device, and a middle handle 19 disposed intermediate upper and lower ends 10, 11 of the device. Likewise, the right side 13 of the lifting sling device comprises upper and lower handles 117, 118 respectively disposed adjacent upper and lower ends 10, 11 of the device, and a middle handle 119 disposed intermediate the upper and lower end 10, 11 of the device.

Preferably a reinforcing strap of webbing material 20, 120 extends from each upper handle 17, 117 to the lower handle 118, 18 on the respective opposite side of the device.

The lower handle 18 of the left side 12 is of the same color as the middle handle 119 of the right side 13. Likewise, the lower handle 118 of the right side 13 is of the same color as the middle handle 19 of the left side 12, the handles 19, 118 being different in color to the respective handles 18, 119 on the opposite sides of the device. The upper handles 17, 117 are the same color as each other but of a different color than the other handles 18, 19, 118, 119.

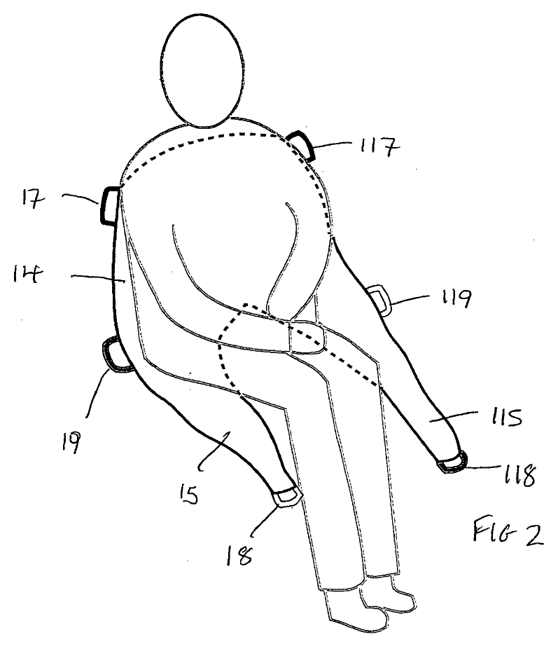

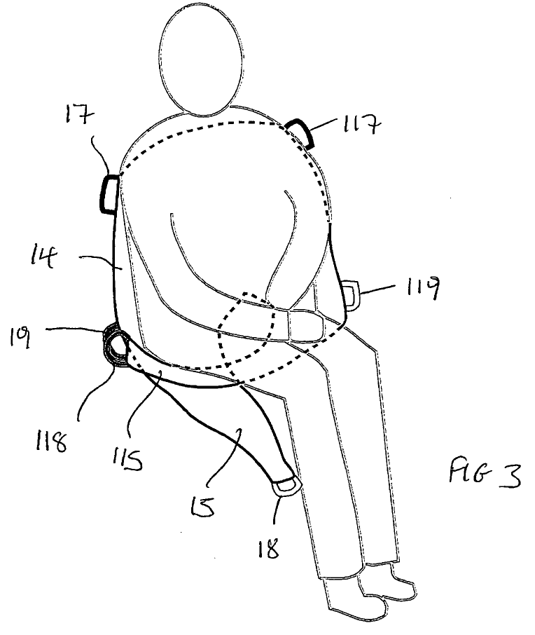

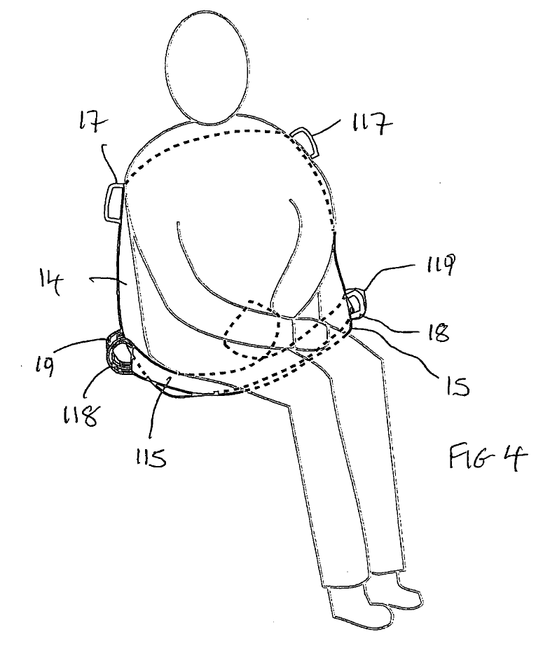

Referring to FIGS. 2 to 4 of the drawings, in use, the device is slipped under a person to be lifted, such that the person's buttocks and lower back rest against the body region 14 of the device, the person's legs extending over respective leg portions 15, 115 of the device.

One of the leg portions e.g. 115 is then passed over the other 15 and under the person's thighs, such that the handles 18, 118 thereon meet the identically-colored middle handles 119, 19 on the opposite side of the device.

The person be lifted by two or more persons, by each person grasping at least one of the upper handles 17, 117 or the brought-together handles 9, 118 and 18, 119. It will be appreciated that the lifting sling device thus allows the person to be lifted comfortably and without risk of injury to either the persons who are lifting or the person being lifted. The leg portions 15, 115 wrap under the thighs of the person being lifted and thus serve to provide further support.

Following use, the device can easily be pulled out from under the person and folded flat for storage.

In an alternative embodiment, the handles may be enlarged allowing two or more persons to grasp each handle. Alternatively, straps or lanyards may be attached to each handle enabling other persons to assist in the lift.

In an alternative embodiment, additional handles may be provided, for example along the upper edge of the device between the two handles 17,117 in order to allow more persons to assist in the lift.

While the preferred embodiments of the invention have been shown and described, it will be understood by those skilled in the art that changes of modifications may be made thereto without departing from the true spirit and scope of the invention.

We claim:

1. A lifting sling device comprising:
a panel of flexible sheet material having a first end, a second end opposite the first end, and opposite sides, said first end comprising a body portion formed of a substantially continuous region of said material, a pair of leg portions extending downwardly from said body region to said second end, wherein each side comprises first and second handles respectively disposed at or adjacent the first and second ends of the device and a third handle disposed intermediate said first and second ends of the device.

2. A lifting sling device as claimed in claim 1, further comprising:
reinforcement disposed along said opposite sides.

3. A lifting sling device as claimed in claim 2, wherein:
said reinforcement is provided by strips of webbing which extend from the first handle on one side of the device to the second handle on the other side of the device.

4. A lifting sling device as claimed in claim 1, wherein:
said handles comprise loops.

5. A lifting sling device as claimed in claim 1, wherein:
said second handles are of different colors with respect to each other and of the same color as the third handle on their respective opposite sides.

6. A lifting sling device as claimed in claim 1, wherein:
said first handles are of the same color with respect to each other and are of a different color with respect to said second handles.

7. A lifting sling device as claimed in claim 1, wherein:
said sides extend outwardly between their opposite ends.

8. A lifting sling device as claimed in claim 1, wherein:
said third handle on each side is positioned closer to its respective first handle than to its respective second handle.

9. A lifting sling device as claimed in claim 1, wherein:
said legs taper inwardly towards said second end of the device.

10. A lifting sling device as claimed in claim 1, wherein:
said legs comprise divergent inner side edges.

11. A method of carrying a person comprising:
placing the person upon a lifting sling device as claimed in claim 1, such that the buttocks of the person rest upon said body portion of the device and the legs of the person extend over the respective legs of the device;
crossing the leg portions of the device over each other to bring the second handles on each side to meet the third handles on respective opposite sides;
lifting the person by grasping said pairs of brought-together handles and said first handles.

12. A method as claimed in claim 11, wherein:
the first handle and the brought-together handles on one side of the device are grasped by the respective hands of one person and the first handle and the brought-together handles on the other side of the device are grasped by the respective hands of another person.

13. A method as claimed in claim 11, wherein:
the first handles on opposite sides of the device are grasped by the respective hands of one person and the brought-together handles on opposite sides of the device are grasped by the respective hands of another person.

14. A method as claimed in claim 11, wherein:
the two first handles and the two sets of brought-together handles are respectively grasped by the hands of four persons.

15. A method as claimed in claim 11, wherein:
the first handles on opposite sides of the device are grasped by the respective hands of one person and the brought-together handles on opposite sides of the device are respectively grasped by the respective hands of two persons.

16. A method as claimed in claim 11, wherein:
the brought-together handles on opposite sides of the device are grasped by the respective hands of one person and the first handles on opposite sides of the device are respectively grasped by the respective hands of two persons.
